(19) United States
(12) Patent Application Publication
(10) Pub. No.: US 2012/0102251 A1
(43) Pub. Date: Apr. 26, 2012

(54) SERIAL ATTACHED SMALL COMPUTER SYSTEM INTERFACE (SAS) DOMAIN ACCESS THROUGH A UNIVERSAL SERIAL BUS INTERFACE OF A DATA PROCESSING DEVICE

(75) Inventors: SHASHI RANJAN, Bangalore (IN); Gooty Bharat Kumar Reddy, Kadapa (IN)

(73) Assignee: LSI Corporation, Milpitas, CA (US)

(21) Appl. No.: 12/910,878

(22) Filed: Oct. 25, 2010

(51) Int. Cl. G06F 13/00

(52) U.S. Cl. 710/300

(57) ABSTRACT

A method, an apparatus and/or a system of serial attached small computer system interface (SAS) domain access through a universal serial bus (USB) interface of a data processing device. A method includes communicatively coupling a serial attached small computer system interface (SAS) domain to the data processing device through the universal serial bus (USB) interface of the data processing device via an expander device. The method also includes accessing a SAS device of the SAS domain and/or the SAS domain through the USB interface of the data processing device via the expander device. The method further includes bridging through a firmware of the expander device between a USB command of the data processing device and a SAS command of the SAS domain to communicate between the data processing device and the SAS domain.

### FIELD OF TECHNOLOGY

This disclosure relates generally to communication of electronic devices and, more particularly, to a method, an apparatus and a system of Serial Attached Small Computer System Interface (SAS) domain access through a Universal Serial Bus (USB) interface of a data processing device.

### BACKGROUND

A Serial Attached Small Computer System Interface (SAS) domain may be a network through which data may be moved between computer storage devices and/or data processing systems. A data processing device (e.g., a general purpose computer, a laptop, a mobile device, etc.) may not be equipped with a SAS compatible port (e.g., Host Bus Adapter (HBA) ports). Therefore, the data processing device may not be able to access and/or communicate with the SAS domain.

### SUMMARY

Disclosed are a method, an apparatus and/or a system of Serial Attached Small Computer System Interface (SAS) domain access through a Universal Serial Bus (USB) interface of a data processing device. In one aspect, a method includes communicatively coupling a SAS domain to a data processing device through a USB interface of the data processing device via an expander device. The method also includes accessing a SAS device and/or the SAS domain through the USB interface of the data processing device via the expander device. The method further includes bridging through a firmware of the expander device between a USB command of the data processing device and a SAS command of the SAS domain to communicate between the data processing device and the SAS domain.

In another aspect, an expander device includes a USB interface to couple the expander device to a data processing device through the USB interface of the expander device via a USB link. The device also includes a SAS interface to couple the expander device to a SAS device of a SAS domain and/or the SAS domain through the SAS interface of the expander device via a SAS link. The expander device communicatively couples the SAS domain to the data processing device. The expander device further includes a firmware module that is configured to bridge a USB command of the data processing device and a SAS command of the SAS domain to communicate between the data processing device and the SAS domain through the USB interface of the data processing device. Furthermore, the expander device includes a switching module of the firmware that is configured to convert through a processor of the expander device the USB command to the SAS command and/or the SAS command to the USB command.

In yet another aspect, a system includes a data processing device having a USB interface. The system also includes a SAS domain including a SAS device. The system further includes an expander device that is configured to communicatively couple a serial attached small computer system interface (SAS) domain to a data processing device through bridging a USB command of the data processing device and a SAS command of the SAS domain via a firmware of the expander device.

The methods and systems disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE VIEWS OF DRAWINGS

Example embodiments are illustrated by way of example and not limitation in the figures of the accompanying drawings, in which like references indicate similar elements and in which:

FIG. 1 illustrates a system view of a serial attached small computer system interface (SAS) domain access through a Universal Serial Bus (USB) interface of a data processing device, according to one or more embodiments.

FIG. 2 illustrates an exploded view of an expander device shown in FIG. 1, according to one or more embodiments.

FIG. 3 is a critical path flow diagram illustrating an establishment of communication between the SAS domain and the data processing device, according to one or more embodiments.

FIG. 4 illustrates a process flow diagram of the SAS domain access through the USB interface of the data processing device, according to one or more embodiments.

Other features of the present embodiments will be apparent from the accompanying drawings and from the detailed description that follows.

### DETAILED DESCRIPTION

Example embodiments, as described below, may be used to provide a method, an apparatus and/or a system of serial attached small computer system interface (SAS) domain access through a universal serial bus (USB) interface of a data processing device. Although the present embodiments have been described with reference to specific example embodiments, it will be evident that various modifications and changes may be made to these embodiments without departing from the broader spirit and scope of the various embodiments.

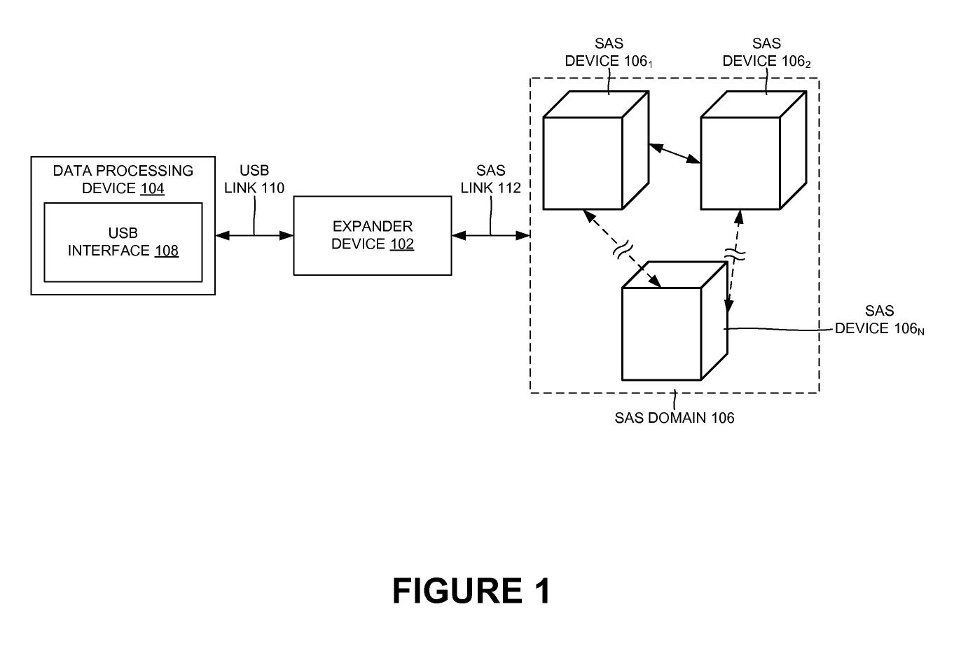

FIG. 1 is a system view of a serial attached small computer system interface (SAS) domain 106 access through a universal serial bus (USB) interface 108 of a data processing device 104, according to one or more embodiments. In particular, the embodiment of FIG. 1 illustrates an expander device 102, the data processing device 104, the USB interface 108, a USB link 110, the SAS domain 106, SAS devices 106_{1-N} of the SAS domain 106 and a SAS link 112.

In one or more embodiments of FIG. 1, the data processing device 104 may be a general purpose computing device (e.g., laptop, desktop, etc.). In some embodiments, the data processing device 104 may be a mobile computing device (e.g., tablet computer, mobile phone, etc.). In one or more embodiments of FIG. 1, the data processing device 104 may include a USB interface 108. In an embodiment of FIG. 1, the data processing device 104 may be coupled to the SAS domain 106 through the expander device 102 via the USB interface 108 of the data processing device 104. In some embodiments, the data processing device 104 may be coupled to a SAS device (e.g., SAS device 106₁) of the SAS devices 106_{1-N}. In the embodiment of FIG. 1, the data processing device 104 may be coupled to the expander device 102 through the USB link 110.

In one or more embodiments of FIG. 1, the USB link 110 may be a wired link and/or a wireless link. In some embodiments, the USB link 110 may be a USB cord with USB connectors on both ends of the cable. The USB connectors on either end of the USB cable may be a Standard-A plug, a Standard-B plug, a mini connector and/or a micro connector based on the USB interface 108 on the data processing device 104 and/or the expander device 102. In certain embodiments, the USB link 110 may be a wireless USB. A wireless USB adapter may be plugged into the USB interface 108 of the data processing device 104. The wireless USB adapter may transmit corresponding USB commands from the data processing device 104. The expander device 102 may be equipped with a USB transmitter/receiver interface to receive the commands transmitted wirelessly from the data processing device 104 through the wireless USB adapter.

The USB interface 108 of the data processing device 104 may be a USB receptacle. In the embodiment of FIG. 1, the expander device 102 may be coupled to the data processing device 104 through the USB interface 108 of the data processing device 104. In one or more embodiments of FIG. 1, the SAS domain 106 may be a network of SAS devices 106_{1-N} Data may be transferred between the SAS devices 106_{1-N} in the SAS domain 106 through a serial data transfer process. The SAS devices 106_{1-N} may include SATA drives. The SAS domain 106 may be a computer bus configured to move data between the storage devices such as hard drives, tape drives. The SAS domain 106 may be coupled to the expander device 102 through a SAS link 112. Each of the SAS devices 106_{1-N} may be a storage device such as a physical storage disk. Each of the SAS devices 106_{1-N} may communicate with each other. In one or more embodiments of FIG. 1, the SAS link 112 may be communication interface to communicatively couple the expander device 102 and the SAS domain 106. In some example embodiments, the SAS link 112 interface may be a 7 pin, a 32 pin and/or a 36 pin interface based on the SAS device 106_{1-N} and/or the interface of the expander device 102.

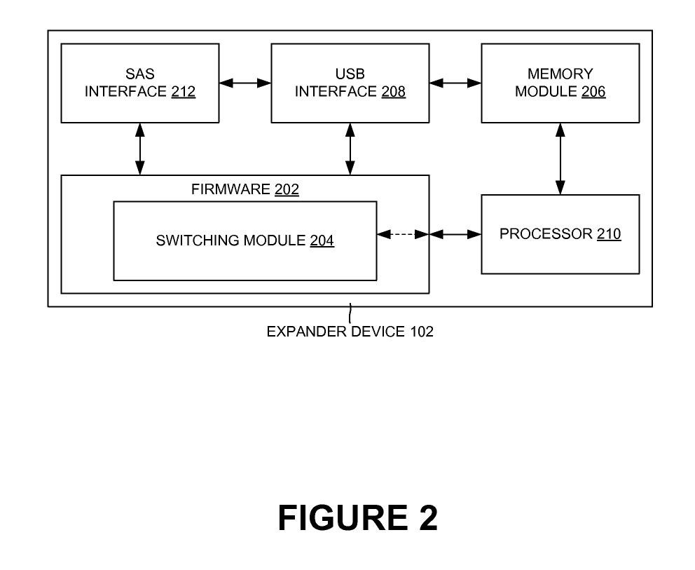

In one or more embodiments of FIG. 1, the expander device 102 may communicatively couple the SAS domain 106 and the data processing device 104. The expander device 102 may be coupled to the SAS domain 106 through a SAS interface (not shown in FIG. 1) port of the expander device 102 via the SAS link 112. In an embodiment of FIG. 1, the expander device 102 may be coupled to the data processing device 104 through the USB interface 108 of the data processing device 104. In the embodiment of FIG. 1, the data processing device 104 may access the SAS devices 106_{1-N} of the SAS domain 106 through the USB interface 108 of the data processing device 104 via the expander device 102. In the embodiment of FIG. 1, the expander device 102 bridges between a USB command of the data processing device 104 and a SAS command of the SAS domain 106 to enable the communication between the data processing device 104 and the SAS domain 106 and thereby an access of the SAS domain 106 from the data processing device 104 through a firmware (not shown in FIG. 1) of the expander device 102. The expander device 102 may be explained further in FIG. 2.

FIG. 2 illustrates an exploded view of the expander device 102 shown in FIG. 1, according to one or more embodiments. In particular, the embodiment of FIG. 2 illustrates a firmware 202, a switching module 204, a memory module 206, a USB interface 208, a processor 210 and a SAS interface 212.

In one or more embodiments, the firmware 202 may be a software which is compiled to generate an executable image. In some embodiments, the executable image may be stored in a memory (not shown in FIG. 2) of the expander device 102. For example, the executable image may be stored in a read only memory. In certain embodiments, the firmware 202 may be a microcode which when executed performs a specific function that the microcode is configured to perform. In the embodiment of FIG. 2, the processor 210 may boot the executable image or link to the executable image that may be stored in a memory of the expander device 102. Operations that the firmware 202 is configured to perform may be executed through the processor 210.

In the embodiment of FIG. 2, the firmware 202 of the expander device 102 enables a communication between the SAS devices 106_{1-N} of the SAS domain 106 and the data processing device 104. The firmware 202 of the expander device 102 also enables an access of the SAS domain 106 through the USB interface 108 of the data processing device 104. In an embodiment of FIG. 2, the firmware 202 of the expander device 102 may be aware of the peripherals that are coupled to the interfaces of the expander device 102 (e.g., USB interface 208, SAS interface 212, etc.) at all times. In another embodiment of FIG. 2, the firmware 202 of the expander device 102 may be made aware of the peripherals coupled to the expander device 102. In some embodiments, awareness of the peripherals that are coupled to the expander device 102 on a necessity basis may enable a power saving.

In one or more embodiments of FIG. 2, the firmware 202 of the expander device 102 enables the access and/or communication between the data processing device 104 and the SAS domain 106 through bridging between commands of the data processing device 104 and the SAS domain 106. The firmware 202 of the expander device 102 may be configured to represent the SAS domain 106 as a USB Mass Storage Device (USB MSD) to the data processing device 104. The firmware 202 of the expander device 102 may respond to the data processing device 104 as a USB MSD response in reply to a request from the data processing device 104 to the SAS domain 106. The SAS domain 106 communication to the data processing device 104 through the expander device 102 may be represented as a USB MSD communication to the data processing device 104. In some embodiments, the communication from the SAS domain 106 to the data processing device 104 through the expander device 102 may appear to the data processing device 104 as a communication from a USB MSD based on the operation that the firmware 202 of the expander device 102 is configured to perform. In certain embodiments, the SAS domain 106 may appear as a USB MSD to the data processing device 104 through the firmware 202 of the expander device 102. The firmware 202 may be configured to represent the SAS domain 106 as a USB MSD to the data processing device 104.

Further, the firmware 202 may be configured to initiate through the processor 210 of the expander device 102, a discovery of a type of a file system the SAS device 106_{1-N} of the SAS domain 106, the number of SAS devices 106_{1-N} forming the SAS domain 106 and the storage capacity of each SAS device 106_{1-N} forming the SAS domain 106 based on a request associated with a USB MSD class related enumeration process from the data processing device 104. The firmware 202 is also configured to respond to the data processing device 104, the information related to SAS domain 106 and/or SAS devices 106_{1-N} of the SAS domain 106.

In some embodiments of FIG. 2, the command from the data processing device 104 may be a USB command. In certain embodiments, the USB command may be a USB MSD class command. The USB MSD class command may be generated through the operating system of the data processing device 104. The USB protocol may have a set of classes. USB MSD class may be one of the set of classes of the USB protocol. The USB MSD command may have a sub class. The sub class of the USB MSD command may be a SAS sub class command. The SCSI sub class command may be generated through the operating system of the data processing device 104. In one or more embodiments, the SCSI sub class command may be natively supported over USB. In the embodiment of FIG. 2, the command from the SAS domain 106 may be a SAS command. In some embodiments, the SAS command may be a SAS primary command.

In the embodiment of FIG. 2, the firmware 202 of the expander device 102 may be configured to receive the USB MSD command and/or a SAS primary command from the data processing device 104 and the SAS domain 106 respectively. The firmware 202 may be configured to analyze the USB MSD command and/or the SAS primary commands that the expander device 102 receives via the USB link 110 and the SAS link 112 respectively.

The switching module 204 of the firmware 202 may be configured to convert the USB MSD commands to a corresponding SAS primary command and vice versa to enable communication between the data processing device 104 and the SAS domain 106. Further, the firmware 202 is configured to communicate the USB MSD command that is converted to the corresponding SAS primary command to the SAS domain 106 and vice versa. The data processing device 104 may communicate a USB command to the SAS domain 106 through the expander device 102. The data processing device 104 may communicate a USB MSD command to the SAS domain 106 because the SAS domain 106 may appear as a USB MSD to the data processing device 104 through an operation of the expander device 102. In an embodiment of FIG. 2, the USB command may be a USB MSD class command. In other embodiments of FIG. 2, the USB command may be another class command of either USB 2.0 or other versions of USB (e.g., USB 3.0).

Further, the firmware 202 may be configured to receive through the USB link 110 a SCSI sub class command from the data processing device 104. The SCSI sub class command may be generated in the data processing device 104. The SCSI sub class command may be a sub class of the USB MSD command. The SCSI sub class command may include a SAS address of the SAS domain 106 and/or a SAS address of the SAS device 106_{1- N} of the SAS domain 106. The switching module 204 of the firmware 202 may be configured to transfer the SCSI sub class command that includes the SAS address of the SAS domain 106 and/or the SAS address of the SAS device 106_{1-N} of the SAS domain 106 to the SAS domain 106 and/or the SAS device 106_{1-N} of the SAS domain 106 via the SAS link 112. The switching module 204 may transfer and/or route the SCSI sub class command from the data processing device 104 to the SAS domain 106 and/or the SAS device 106_{1-N} of the SAS domain 106 based on the address of the SAS domain and/or the SAS device 106_{1-N} of the SAS domain 106 included in the SCSI sub class command. The switching module 204 may be a microcode of the firmware 202 configured to transfer a compatible command from a data processing device 104 to a SAS domain 106 and vice versa. The switching module 204 may also be configured to convert the SAS commands to USB commands and vice versa.

In one or more embodiments of FIG. 2, the memory module 206 may buffer the USB command and/or the SAS command to improve a speed of communication between the data processing device 104 and the SAS domain 106. In some embodiments, the SAS domain 106 may be slower than the data processing device 104. Buffering the commands from the SAS domain 106 and the data processing device 104 in a cache may reduce an effect of the speed mismatch between the SAS domain 106 and the data processing device 104. In certain embodiments, the memory module 206 may be a cache memory. In an example embodiment of FIG. 2, USB commands may be time critical and the expander device 102 may need to store some details in the memory module 206 (e.g., cache memory) of the expander device 102 to respond faster. In the example embodiment, the expander device 102 may populate the memory module 206 (e.g., cache) on a necessity basis.

In an embodiment of FIG. 2, the USB interface 208 of the expander device 102 may be a USB receptacle (e.g., USB port). The USB interface 208 of the expander device 102 may be an interface through which the data processing device 104 may be coupled to the expander device 102 via the USB link 110. The USB link 110 may be coupled to the expander device 102 through the USB interface 208 of the expander device 102. In another example embodiment of FIG. 2, the USB interface 208 may be a USB plug that is a part of the expander device 102 to which a USB link 110 may be coupled. In the example embodiment of FIG. 2, the USB link 110 may be a USB cable with one end being a USB receptacle and the other end being a USB plug. Further in the example embodiment, the end of the USB link 110 that is a USB receptacle may be coupled to the USB plug that is a part of the expander device 102 as mentioned above in the example embodiment. In the example embodiment, the expander device 102 with the USB plug as the USB interface 208 may also be directly plugged to the data processing device 104 through the USB interface 108 of the data processing device 104. The USB link 110 may also be a wireless link. In yet another example embodiment, the expander device 102 may also be coupled to the USB interface 108 of the data processing device 104 through a different type of interface of the expander device 102. For example, when the USB link 110 is a cable with a USB plug on one end and a plug that is compatible with a different interface of the expander device 102 on the other end, the data processing device 104 is coupled to the expander device 102 through a USB interface 108 of the data processing device 104 and the different interface of the expander device 102 via the USB link 110.

In the embodiment of FIG. 2, the SAS interface 212 may be an interface through which the SAS domain 106 may be coupled to the expander device 102 via the SAS link 112. The SAS interface 212 may either be a SAS compatible plug or a SAS compatible receptacle.

In one or more embodiments of FIG. 2, the processor 210 may boot the firmware 202. The switching module 204 may perform the conversion and/or transforming the USB commands to the SAS commands and vice versa through the processor 210. The processor 210 may perform operations of analyzing the commands that are received from the data processing device 104 and the expander device 102. The processor 210 may execute the commands received from the data processing device 104 and the SAS domain 106. The processor 210 may also execute commands from the memory module 206 and/or the switching module 204 of the firmware 202 of the expander device 102.

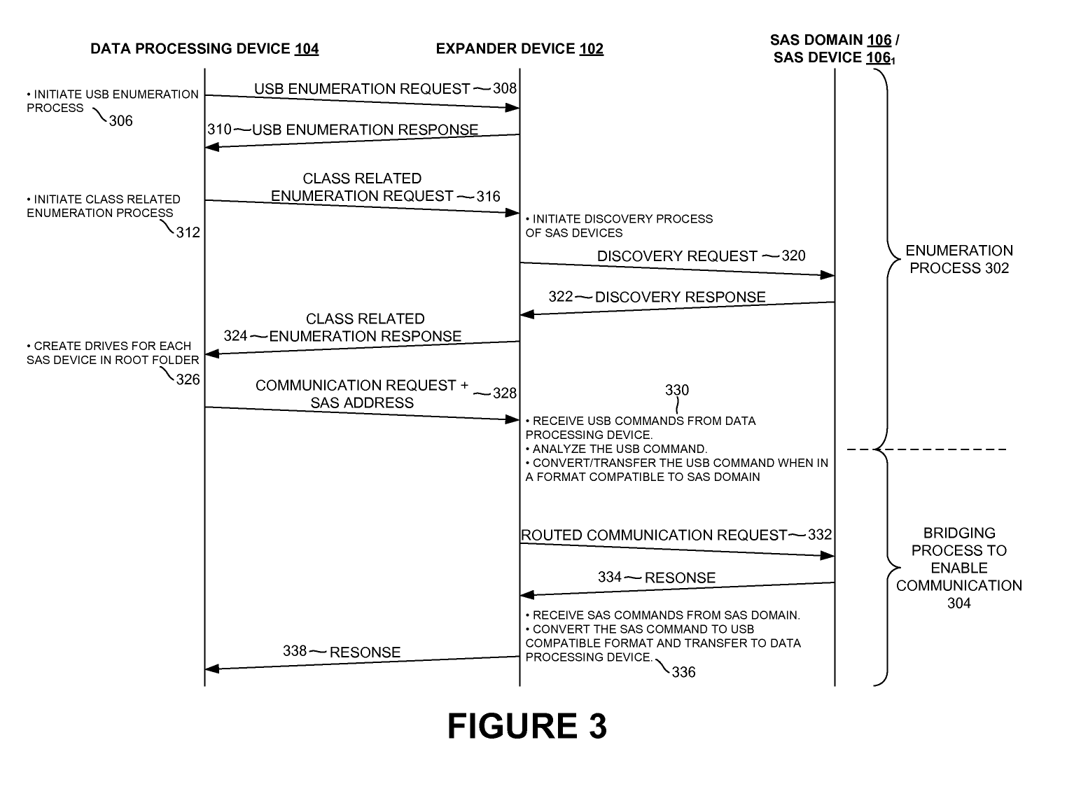

FIG. 3 is a critical path flow diagram illustrating the establishment of communication between the SAS domain 106 and data processing device 104, according to one or more embodiments. In particular, the embodiment of FIG. 3 illustrates an enumeration process 302 and a bridging process to enable communication 304 between the SAS domain 106 and the data processing device 104 through the expander device 102. In the embodiment of FIG. 3, the enumeration process 306 may include, but not limited to operation 306 to operation 324. The bridging process to enable communication 304 may include, but not limited to operation 326 to operation 338.

In the embodiment of FIG. 3, when the expander device 102 is coupled to the data processing device 104 via the USB link 110 as illustrated in FIG. 1, the data processing device 104 may start a USB enumeration process to inform the data processing device 104 the type of USB peripheral coupled to the USB interface 108 of the data processing device 104 in operation 306. In operation 308, the data processing device 104 may send a USB enumeration based request to the expander device 102 that is coupled to the USB interface 108 of the data processing device 104. The expander device 102 may be coupled to the SAS domain 106 and the data processing device 104. In operation 310, the expander device 102 may respond to the USB enumeration request of the data processing device 104 through listing the type of USB peripheral coupled to the data processing device 104 as a USB Mass Storage Device (USB MSD) via a USB enumeration based response.

In operation 312, when the data processing device 104 gets a response that the USB peripheral coupled to the data processing device 104 is a USB MSD, then the data processing device 104 may initiate a class related enumeration. In some embodiments, the class related enumeration may be a USB MSD class related enumeration. In certain embodiments, the USB MSD class related enumeration process may list the number of logic end device (e.g., peripherals) coupled to the data processing device 104 through the USB interface 108 of the data processing device 104. In operation 316, the data processing device 104 may communicate a class based enumeration request to the expander device 102 to list the number of logic end device (e.g., peripherals) coupled to the data processing device 104 through the USB interface 108 of the data processing device 104. In operation 318, when the expander device 102 receives a class based enumeration request from the data processing device 104, the expander device 102 may initiate a discovery process of the SAS domain 106 to determine the number of SAS devices 106_{1-N} of the SAS domain 106 coupled to the data processing device 104 through the expander device 102. In operation 320, the expander device 102 may communicate a discovery request to the SAS domain 106. In operation 322, the SAS domain 106 may respond with a discovery request based response that may list the SAS device 106_{1-N} of the SAS domain 106 that may be coupled to data processing device 104 through the expander device 102. The SAS domain 106 may send the discover response to the expander device 102 in operation 322. In one or more embodiments of FIG. 3, in operation 324, the expander device 102 may respond to the data processing device 104 in reply to a class related enumeration of the data processing device 104 through listing the number of SAS devices 106_{1-N} of the SAS domain 106 coupled to the expander device 102 through the SAS link 112. The expander device 102 may send a class related enumeration response to the data processing device 104 in operation 324. Further, in operation 324 the expander device 102 may provide an information of the capacity and/or size of each of the listed SAS devices 106_{1-N} of the SAS domain 106 to the data processing device 104.

In operation 326, the data processing device 104 may provision a drive in a root folder of the data processing device 104 through the operating system of the data processing device 104 for each of the SAS devices 106_{1-N} of the SAS domain 106 that are listed through the class related enumeration process. The operating system of the data processing device 104 may initiate the USB enumeration process and/or the class related enumeration process.

Further, in operation 326, when an access of the drive associated with one a SAS device 106₁ of the SAS domain 106 is requested, a communication process may be initiated. In operation 328, the data processing device 104 sends a USB command to the expander device 102 to communicate with the SAS device 106₁. The USB command may include a SAS address of the SAS device 106₁. The USB command may be a SCSI sub class command. The SCSI sub class command may be a sub class of the USB MSD command. The SCSI sub class command may be generated in the data processing device 104. In operation 330, the expander device 102 may receive the SCSI sub class command from the data processing device 104 to communicate with the SAS device 106₁. In operation 330, the expander device 102 may analyze the SCSI sub class command through the processor 210 of the expander device 102. In an embodiment of FIG. 3, in operation 330, the switching module 204 of the firmware 202 may route and/or transfer the SCSI sub class command to the SAS device 106₁ based on the SAS address of the SAS device 106₁ included in the SCSI sub class command that the expander device 102 received from the data processing device 104. In another embodiment of FIG. 3, in operation 330 the switching module 204 of the firmware 202 may convert a USB MSD command from the data processing device 104 to a SAS compatible command (e.g., SAS command, SPC, etc.). In operation 332, the expander device 102 may transfer the SCSI sub class command and/or the USB MSD commands that have been converted to the SAS compatible command of the SAS domain 106. In operation 332, the expander device 102 may route the commands from the data processing device 104 to the SAS device 106₁ based on the SAS address included in the SCSI sub class command and/or the USB MSD command.

In operation 334, the SAS device 106₁ may communicate a response to the data processing device 104 through the expander device 102 based on the request received through the command from the data processing device 104 through the expander device 102. In operation 336, the expander device 102 may receive the response SAS commands from the SAS device 106₁ of the SAS domain 106. In operation 336, the expander device 102 may convert the SAS command (e.g., SPC) to a USB compatible command (e.g., SCSI sub class command, USB MSD command, USB command, etc.). In operation 338, the expander device 102 may communicate to the data processing device 104, the SAS command that is converted to a USB compatible command. The expander device 102 may buffer the USB commands and/or the SAS commands from the data processing device 104 and/or the SAS domain 106 in operations 318, 330 and/or 338.

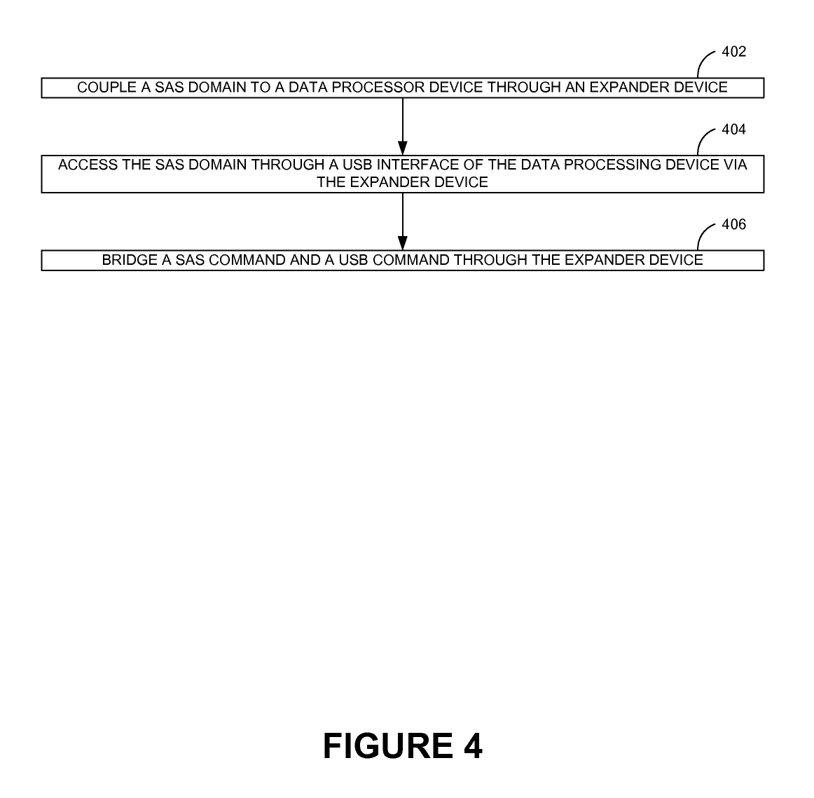

FIG. 4 illustrates a process flow diagram of the SAS domain access through the USB interface 208 of the data processing device 104, according to one or more embodiments. In operation 402, the data processing device 104 may be communicatively coupled to a SAS domain 106 through the USB interface 108 of the data processing device 104 via the expander device 102. The SAS domain 106 may include one or more SAS devices 106_{1-N}. The SAS devices 106_{1-N} in the SAS domain 106 may be coupled to each other and/or may communicate with each other. In operation 404, the data processing device 104 may access the SAS domain 106 through the expander device 102. The data processing device 104 may communicate a system command through the operating system of the data processing device 104 to the expander device 102. The system command from the data processing device 104 may be communicated to the expander device 102 to identify the USB device coupled to the USB interface 108 of the data processing device 104. The expander device 102 may respond to inform the data processing device 104 that a mass storage device (e.g., USB MSD) is coupled to the USB interface 108 of the data processing device 104. The data processing device 104 may generate and communicate a mass storage device command (e.g., USB MSD command, USB commands) to the expander device 102. In operation 406, the expander device 102 may bridge through a firmware 202 of the expander device 102 between a USB command (e.g., USB MSD command, SCSI sub class command, etc.) of the data processing device 104 and a SAS command (e.g., SPC) of the SAS domain 106 to enable the access and/or the communication between the data processing device 104 and the SAS domain 106.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware, firmware and software (e.g., embodied in a machine readable medium). For example, the various electrical structure and methods may be embodied using transistors, logic gates, and electrical circuits (e.g., application specific integrated (ASIC) circuitry and/or in digital signal processor (DSP) circuitry).

In addition, it will be appreciated that the various operations, processes, and methods disclosed herein may be embodied in a machine-readable medium and/or a machine accessible medium compatible with a data processing system (e.g., a computer devices), may be performed in any order (e.g., including using means for achieving the various operations). Accordingly, the specification and drawings are to be regarded in an illustrative rather than a restrictive sense.

What is claimed is:

1. A method comprising:
communicatively coupling a Serial Attached Small Computer System Interface (SAS) domain to a data processing device through a universal serial bus (USB) interface of the data processing device via an expander device;
accessing at least one of a SAS device of the SAS domain and the SAS domain through the USB interface of the data processing device via the expander device; and
bridging through a firmware of the expander device between a USB command of the data processing device and a SAS command of the SAS domain to communicate between the data processing device and the SAS domain.

2. The method of claim 1, wherein the bridging through the firmware of the expander device between a USB command of the data processing device and a SAS command of the SAS domain, further comprising:
receiving, in the expander device, the USB command from the data processing device coupled to the expander device through a USB link;
analyzing, in the expander device, the USB command from the data processing device coupled to the expander device through a USB link;
converting, through a switching module in the firmware of the expander device, the USB command to a corresponding SAS command; and
transmitting the corresponding SAS command that is converted to the SAS domain through the expander device via a SAS link.

3. The method of claim 2:
wherein the USB command of the data processing device is a Universal Serial Bus Mass Storage Device (USB MSD) command generated through the data processing device,
wherein the SAS command of the SAS domain is a SCSI primary command, and
wherein the data processing device to start an enumeration operation to list SAS devices of the SAS domain when the data processing device detects a coupling of the USB link to the data processing device.

4. The method of claim 1, wherein bridging through the firmware of the expander device between a USB command of the data processing device and a SAS command of the SAS domain, further comprising:
receiving, in the expander device through the USB link, a SCSI sub class command from the data processing device, the SCSI sub class command comprising at least one of a SAS address of the SAS domain and a SAS address of the at least one SAS device of the SAS domain, wherein the SCSI sub class command is a sub class of a Universal Serial Bus Mass Storage Device (USB MSD) command; and
transferring, through the expander device, the SCSI sub class command comprising at least one of a SAS address of the SAS domain and a SAS address of the at least one SAS device of the SAS domain to at least one of the SAS domain and the at least one SAS device of the SAS domain via a SAS link based on the address comprised in the SCSI sub class command.

5. The method of claim 2, further comprising:
receiving, in the expander device, the SAS command from the SAS domain coupled to the expander device through a SAS link;
converting, through the switching module in the firmware of the expander device, the SAS command to a corresponding USB command; and
communicating, through the expander device, the SAS command that is converted to the corresponding USB command to the data processing device via the USB link.

6. The method of claim 1, further comprising:
initiating, through the expander device when the data processing device begins a USB MSD class related enumeration process, a discovery of at least one of a type of a file system of the at least one SAS device of the SAS domain, the number of SAS devices forming the SAS domain and storage capacity of each SAS device forming the SAS domain based on a request associated with the USB MSD class related enumeration process;
responding, through the expander device, to the USB MSD related class enumeration process of the data processing device as a USB MSD; and
presenting, through the expander device, the SAS domain as a USB MSD to the data processing device.

7. The method of claim 1, further comprising:
buffering, in a memory module of the expander device, at least one of the USB command and the SAS command to improve a speed of communication between the data processing device and the SAS domain, wherein the memory module is a cache memory.

8. The method of claim 1:
wherein the expander device comprises at least one of a USB interface and a SAS interface,
wherein the USB link is coupled to the data processing device through the USB interface of the data processing device,
wherein the USB link is coupled to the expander device through the USB interface of the expander device, and
wherein the SAS link is coupled to the expander device through the SAS interface on the expander device.

9. The method of claim 1 in a form of a machine-readable medium embodying a set of instructions that, when executed by a machine, cause the machine to perform the method of claim 1.

10. An expander device comprising:
a Universal Serial Bus (USB) interface to couple the expander device to a data processing device through the USB interface of the expander device via a USB link;
a Serial Attached Small Computer System Interface (SAS) interface to couple the expander device to at least one of a SAS device of a SAS domain and the SAS domain through the SAS interface of the expander device via a SAS link, the expander device to communicatively couple the SAS domain to the data processing device;
a firmware module configured to bridge a USB command of the data processing device and a SAS command of the SAS domain to communicate between the data processing device and the SAS domain through the USB interface of the data processing device; and
a switching module of the firmware configured to convert, through a processor of the expander device, at least one of the USB command to the SAS command and the SAS command to the USB command.

11. The expander device of claim 10:
wherein the USB command of the data processing device is a Universal Serial Bus Mass Storage Device (USB MSD) command generated through the data processing device, and
wherein the SAS command of the SAS domain is a SCSI primary command.

12. The expander device of claim 10, further comprising:
a memory module to buffer at least one of the USB MSD command and the SCSI Primary command to improve a speed of communication between the data processing device and the SAS domain, wherein the memory module is a cache memory.

13. The expander device of claim 10, wherein the firmware of the expander device configured to:
receive the USB MSD command from the data processing device coupled to the expander device through a USB link;
analyze the USB MSD command received from the data processing device coupled to the expander device through a USB link;
receive the SCSI primary command from the SAS domain coupled to the expander device through a SAS link; and
communicate the SCSI primary command that is converted to the corresponding USB MSD command to the data processing device via the USB link.

14. The expander device of claim 13, wherein the firmware of the expander device configured to:
receive, through the USB link, a SCSI sub class command comprising at least one of a SAS address of the SAS domain and a SAS address of the at least one SAS device of the SAS domain, the SCSI sub class command is generated through the data processing device is a sub class of the USB MSD command, wherein the SCSI sub class command is a sub class of the USB MSD command; and
transfer the SCSI sub class command comprising at least one of a SAS address of the SAS domain and a SAS address of the at least one SAS device of the SAS domain to at least one of the SAS domain and the at least one SAS device of the SAS domain via a SAS link based on the address comprised in the SCSI sub class command.

15. The expander device of claim 10, wherein the firmware of the expander device configured to:
initiate, through the processor of the expander device when the data processing device begins a USB MSD class related enumeration process, a discovery of at least one of a type of a file system of the at least one SAS device of the SAS domain, the number of SAS devices forming the SAS domain and the storage capacity of each SAS device forming the SAS domain based on a request associated with the USB MSD class related enumeration process;
respond to the USB MSD related class enumeration process of the data processing device as a USB MSD; and
present the SAS domain as a USB MSD to the data processing device.

16. A system comprising:
a data processing device comprising a Universal Serial Bus (USB) interface;
a Serial Attached Small Computer System Interface (SAS) domain comprising an at least one SAS device; and
an expander device configured to communicatively couple the SAS domain to the data processing device through bridging a USB command of the data processing device and a SAS command of the SAS domain via a firmware of the expander device.

17. The system of claim 16, wherein the expander device further comprising:
a memory module to buffer at least one of the USB command and the SAS command to improve a speed of communication between the data processing device and the SAS domain, the memory module is a cache memory, wherein:
the USB command of the data processing device is a USB Mass Storage Device (USB MSD) command generated through the data processing device, and
the SAS command of the SAS domain is a SCSI primary command; and
a switching module of the firmware to convert, through a processor of the expander device, at least one of the USB MSD command to the SCSI primary command and the SCSI primary command to the USB MSD command.

18. The system of claim 16, wherein the firmware of the expander device configured to:
receive the USB MSD command from the data processing device coupled to the expander device through a USB link;
analyze the USB MSD command received from the data processing device coupled to the expander device through a USB link;
receive the SCSI primary command from the SAS domain coupled to the expander device through a SAS link; and
communicate the SCSI primary command that is converted to the corresponding USB MSD command to the data processing device via the USB link.

19. The system of claim 16, wherein the firmware of the expander device configured to:
receive, through the USB link, a SCSI sub class command comprising at least one of a SAS address of the SAS domain and a SAS address of the at least one SAS device of the SAS domain, the SCSI sub class command is generated through the data processing device is a sub class of the USB MSD command, wherein the SCSI sub class command is a sub class of a USB MSD command of the data processing device;
transfer the SCSI sub class command comprising at least one of a SAS address of the SAS domain and a SAS address of the at least one SAS device of the SAS domain to at least one of the SAS domain and the at least one SAS device of the SAS domain via a SAS link based on the address comprised in the SCSI sub class command;
initiate, through the processor of the expander device when the data processing device begins a USB MSD class related enumeration process, a discovery of at least one of a type of a file system of the at least one SAS device of the SAS domain, the number of SAS devices forming the SAS domain and the storage capacity of each SAS device forming the SAS domain based on a request associated with the USB MSD class related enumeration process;
respond to the USB MSD related class enumeration process of the data processing device as a USB MSD; and
present the SAS domain as a USB MSD to the data processing device.

20. The system of claim 16, wherein the data processing device configured to:
communicatively couple the data processing device to the expander device through the USB interface of the data processing device via the USB link;
initiate, through an operating system of the data processing device, the enumeration process when the USB link is coupled to the data processing device to list at least one of a number of devices coupled to the data processing device and the type of devices coupled to the data processing device;
generate the SCSI sub class commands through the operating system of the data processing device, wherein the SCSI sub class command is a sub class of the USB MSD command; and
transmit the SCSI sub class commands to the SAS domain through the expander device.
